(19) United States
(12) Patent Application Publication
(10) Pub. No.: US 2016/0223035 A1
(43) Pub. Date: Aug. 4, 2016

(54) Torque-controlled braking device for driven tools

(71) Applicant: SOLO Kleinmotoren GmbH, Sindelfingen (DE)

(72) Inventor: Samuel Schinkel, Weil der Stadt (DE)

(21) Appl. No.: 15/007,679

(22) Filed: Jan. 27, 2016

(30) Foreign Application Priority Data
Jan. 30, 2015 (DE) 20 2015 000 702.3

(51) Int. Cl. F16D 51/22

(52) U.S. Cl. CPC F16D 51/22; F16D 2121/14

(57) ABSTRACT

The invention relates to a braking device for a driven tool, including a shaft, a fixed brake drum, a drive element, a brake shoe holder joined in a manner fixed against relative rotation to the shaft, wherein at least one brake shoe is pivotably located on the brake shoe holder, and wherein the brake shoe is activated when power or torque is transmitted from the shaft to the drive element.

Driven tools, such as cutting grinders, brush cutters, circular saws and others, are very high-performance tools, among other reasons because of their high cutting speeds. Rotating or revolving tools, in particular, because of their inertia and the high operating rpm, have a considerable potential for danger as they run down. Driven tools in the sense of the invention are both hand-guided tools and stationary tools, such as a table circular saw.

In terms of the invention, “running down” is what the state that immediately follows the normal operating state is called. The operating state is characterized in that power is transmitted from the drive motor to the tool and the tool has reached its rated or operating speed. If—from the working state—the drive motor is made to idle or is switched off, then power is no longer transmitted from the drive motor to the tool, and the tool continues to rotate because of its inertia; it “runs down”.

Because cutting grinders have operating speeds of 10,000 revolutions per minute and more, an unbraked run-down of the cutting disk would last a very long time, and as long as the cutting disk is rotating, it can injure someone or unintentionally damage or even destroy objects that come into contact with the rotating cutting disk. Therefore, for the sake of work safety and efficiency among other reasons, it is necessary for the tool to be actively braked immediately after the drive motor is switched off, or immediately after the drive motor has been shifted to idle, with the goal of bringing the tool to a stop within from one to two seconds if at all possible.

From German Utility Model DE 20 2009 005 935 U1 and International Application WO 2008/103079 A1, braking devices are known that are switched on and off with the aid of flyweights.

One disadvantage of these braking devices is that the switch-on point of the centrifugally controlled brakes must be designed to be below the operating speed of the working tool, to avoid a braking action while work is being done with the tool. Because the braking device is switched by the flyweights, it does not become operative until below a certain rpm, which is markedly lower than the maximum rpm of the working tool. As a result, only an inadequate braking influence can be exerted on the total braking time (from maximum rpm to a stop).

A further disadvantage is that these braking devices require a certain minimum rpm in order to deactivate the braking action. As a result, this lengthens the time that is needed to accelerate the drive motor from the idling rpm to the rated rpm.

A further disadvantage is that the amount of the braking torque is dependent on the rpm.

The object of the invention is to furnish a braking device for driven tools which avoids the disadvantages of the prior art, is compact in structure, can be produced economically, and ideally can be retrofitted into mass-produced tools. Last but not least, the braking device of the invention should be powerful and safe.

This object is attained according to the invention by a braking device having the features of claim 1.

The braking device of the invention is activated as soon as the power flow from the drive motor to the tool is interrupted. As a result, the braking time of the tool from the operating rpm to a stop is shortened markedly, among other reasons because the braking device of the invention operates over virtually the entire rpm range of the working tool. Alternatively to the toggle lever explained in detail, the control of the brake according to the invention can also be done by means of a cam drive, in particular a sliding block guide or ramp.

As soon as power is transmitted from the drive motor to the tool, the braking device of the invention is deactivated without a time lag, and the drive motor can accelerate the tool unbraked.

A further advantage of the braking device of the invention can be seen in that it is not actuated via cables, rods, or the like. As a result, its inclusion into the drive train of a tool is simpler. The number of components required drops, and because external actuation elements are always a potential source of problems, the braking device of the invention is very sturdy and has a long service life.

Because of its very compact construction without external adjusting elements, the braking device of the invention can often be retrofitted into or offered as an option for existing mass-produced tools. The actual tool need not be changed for the purpose, or needs to be changed only very slightly, which likewise has major commercial advantages.

In a further advantageous embodiment of the invention, a stop is embodied on the brake shoe holder; this stop limits the travel of the toggle lever and serves to transmit torque positively from the drive element to the shaft.

This means that if the line connection goes from the motor to the tool, there is a rigid connection between the drive element and the tool, so that even high drive power levels]] can be transmitted without loss. The positive force transmission takes place from the drive element via the toggle lever, which contacts the stop of the brake shoe holder. Because according to the invention the brake shoe holder is connected to the shaft in a manner fixed against relative rotation, and the tool is in turn connected to the shaft in a manner fixed against relative rotation, a flow of power from the drive element to the tool is thus assured, whenever the drive motor is driving the tool.

Depending on how the stop is positioned on the brake shoe holder relative to the dead center of the toggle lever, the torque required to activate the braking device can be fixed constructively over wide ranges. This is a further major advantage of the braking device of the invention. As a result, it can easily be adapted to the most various tools, with different moments of inertia and operating rpm.

To save on installation space, above all in the axial direction, it can be advantageous for the drive element to be supported rotatably on an as a rule cylindrical bearing face of the brake shoe holder. Alternatively, it is understood also to be possible for the drive element to be supported separately; for example, it may be axially offset from the shaft or the brake shoe holder. As a result, the construction space in the axial direction can be minimized; however, the structural length then increases. Here the question must be weighed for each particular application as to which structural variant is given preference.

To enable adjusting the contact pressure by which the brake shoes are pressed against the brake drum when the braking device is activated, and to make it independent of the shaft rpm, it is provided that a spring be located between the brake shoe holder and the brake shoe. This spring will as a rule be a compression spring. Its spring force seeks to press the brake shoe outward in the direction of the brake drum, if the brake drum has a braking surface that is embodied as a female cylinder.

If the brake drum has a braking surface that is embodied as a male cylinder, then the brake shoe must be pressed by the spring or springs against the brake drum from outside, counter to the centrifugal force. This can be accomplished for example by means of tension springs and/or suitably designed and prestressed leaf springs. In principle, it is possible to use any kind of spring.

In the braking device of the invention, it is possible, by means of flyweights or distributing the mass of the brake shoe, to adjust the contact pressure, by which the brake shoe is pressed against the brake drum, constructively. If the brake shoe acts from the inside outward against a brake drum having a braking surface that is embodied as a female cylinder, then the centrifugal force acting on the brake shoes reinforces the contact pressure. In that case the braking action at high rpm of the tool is especially strong and decreases as the rpm of the tool drops. This course of the contact pressure as a function of the rpm is desired in a great many cases, because at high rpm the kinetic energy of the driving tool is very high and therefore a strong braking power is desired.

However, if to a certain extent a flyweight is provided on the other side of the pivot point of the brake shoe as a counterweight to the mass of the brake shoe itself, then the effect of the centrifugal force on the contact pressure of the brake shoe can be compensated for entirely or partially. It is also possible constructively, by means of the flyweights, to specify a brake shoe contact pressure that increases with decreasing rpm.

Further advantages of the braking device of the invention are shown and described below on the basis of the drawings.

### DRAWINGS

Shown are:

FIG. 1: a side view of one exemplary embodiment of a braking device of the invention;

FIG. 2: a longitudinal section along the line A-A in FIG. 3;

FIG. 3: a sectional view along the line B-B in FIG. 2;

FIG. 4: the view of FIG. 3 with an activated braking device;

FIG. 5: the view of FIG. 3 with a deactivated braking device;

FIG. 6: a brake shoe holder of the invention;

FIG. 7: a toggle lever of the invention;

FIG. 8: a brake shoe of the invention; and

FIG. 9: a brake shoe of the invention with a flyweight.

### DESCRIPTION OF THE EXEMPLARY EMBODIMENT

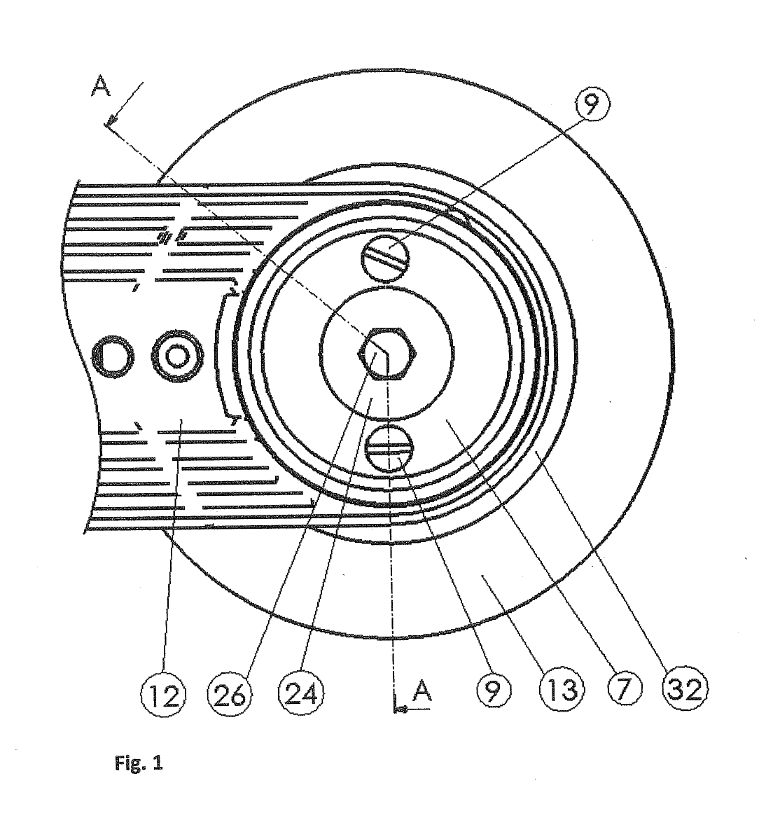

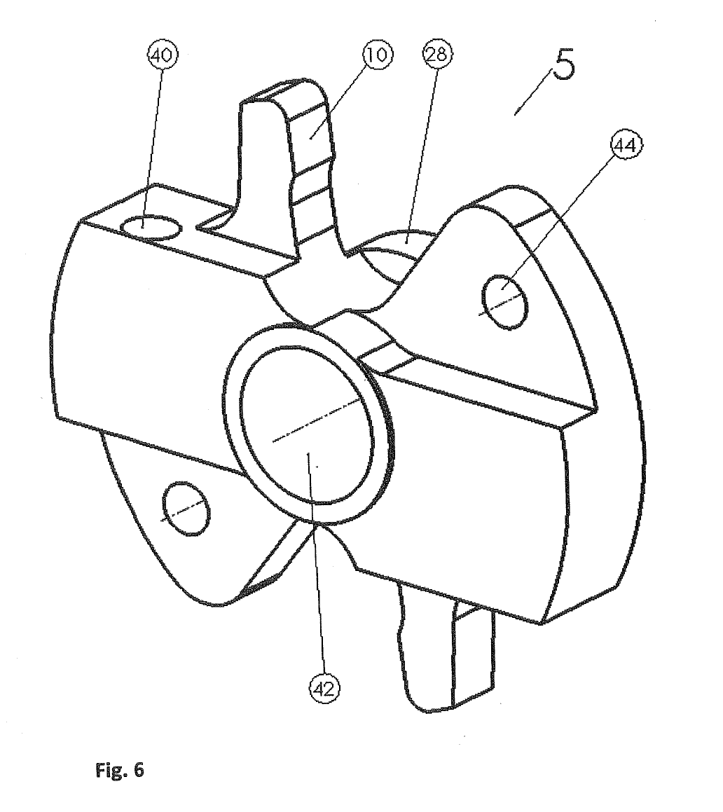

In FIGS. 1 through 5, an exemplary embodiment of a braking device of the invention is shown in the assembled stated in various views, while FIGS. 6 through 9 show individual parts of the braking device of the invention, namely a brake shoe holder, a toggle lever and a brake shoe by themselves.

First, in FIG. 1 a side view of the braking device of the invention is shown. In this side view, a drive element 7 can be seen, which may for example be a pulley or a gear wheel. In the present case it is a pulley; however, the invention is not limited to that.

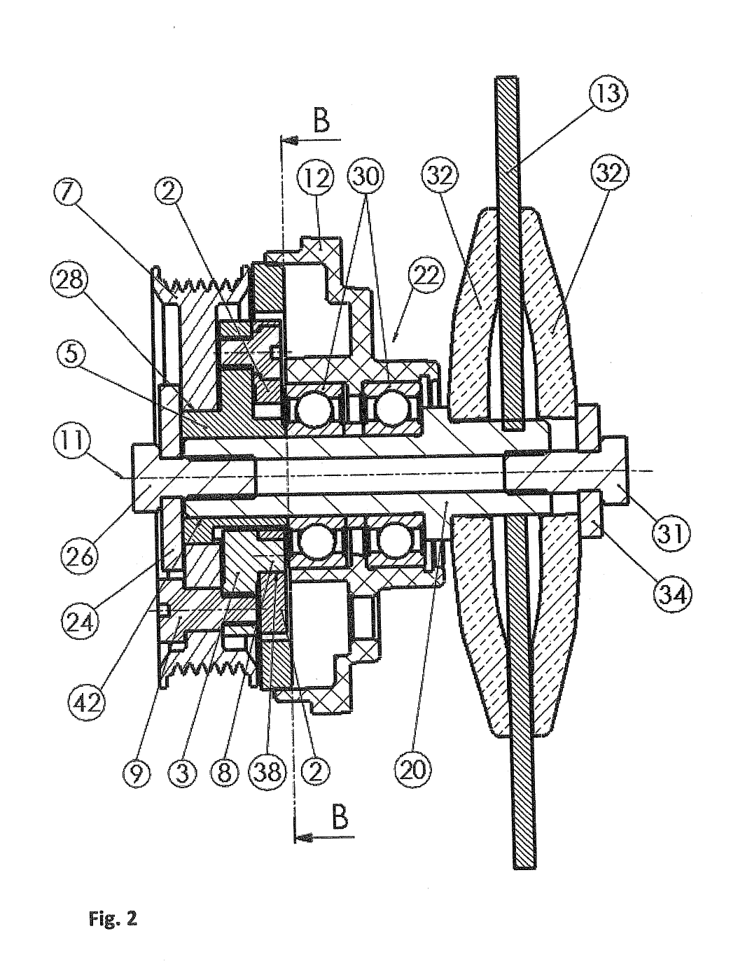

The drive element is supported rotatably indirectly on a shaft 20 (see FIG. 2). The actual support of the drive element 7 on a cylindrical bearing face 28 of a brake shoe holder 5 cannot be seen in FIG. 1. The drive element 7 is retained in the axial direction by a disk 24, which in turn is connected to the shaft 20 by means of a central screw 26. The disk 24 prevents the drive element from slipping off the shaft 20 in the axial direction. A tool, such as a cutting disk, is provided with reference numeral 13. Reference numeral 32 designates a clamping flange.

Two bearing bolts 9, which act as bearing points for two toggle levers (not visible) in FIG. 1, are screwed into the drive element 7.

In FIG. 2, a longitudinal section through the braking device of the invention along the line A-A in FIG. 1 is shown. Identical components are identified by the same reference numerals. Reference numeral 12 designates a mounting or a bearing block for the bearing 22 of the shaft 20. In other words, this mounting 12 does not rotate. The bearing 22 of the shaft 20 is implemented in the exemplary embodiment shown with the aid of two roller bearings 30. Between the roller bearings 30, an offset is formed on the mounting 12, so that the outer rings of the bearings 30 cannot shift in the axial direction relative to the mounting 12. Any securing disks (Seeger rings) and/or radial packing rings that may be present are not shown.

A tool, such as a diamond grinding disk, is clamped between two clamping flanges 32, on the right end of the shaft 20 in FIG. 2, and is thereby connected to the shaft 20 in a manner fixed against relative rotation. One skilled in the art in the field of driven tools, especially in the field of tcs, is quite familiar with fastening the tool 13 to the shaft 20, so that a detailed description can be dispensed with. Between the (clamping) screw 31 and the clamping flange 32 on the right in FIG. 2, a disk 34 is provided.

The left clamping flange 32 in FIG. 2 is braced against an offset (not identified by reference numeral) of the shaft 20 in the axial direction, which thus acts as the buttress for the axial force exerted on the screw 31. By this axial force, the tool 13 is clamped between the clamping flanges 32.

The offset on the left side of the left clamping flange 32 of the shaft 20 simultaneously fixes the inner ring of the one roller bearing 30 in the axial direction. Thus the right bearing 30 in FIG. 2 is the fixed bearing, and the left roller bearing 30 is the loose bearing.

On the left side of the left bearing 30, a brake shoe holder 5 is slipped onto the shaft 20. The brake shoe holder 5 is clamped to the inner ring of the left bearing 30 in the axial direction via the disk 24 and the screw 26. The brake shoe holder 5 is connected to the shaft 20 in a manner fixed against relative rotation.

The structural embodiment of the brake shoe holder will now be described in detail. First, however, it is significant that the brake shoe holder 5 has a cylindrical bearing face 28. This cylindrical bearing face 28 receives the drive element 7, so that the drive element 7 is supported rotatably on the cylindrical bearing face 28. The drive element 7 can rotate relative to the brake shoe holder 5 and thus also relative to both the shaft 20 and the tool 13 secured to the shaft.

A brake drum 1 is fixedly located on the mounting 12. With the aid of the bearing bolts 9, two toggle levers 3 are pivotably secured to the drive element 7. On the radially inner end of the toggle lever 3, a peg 8 is embodied, which in turn engages a corresponding bore in the brake shoe 2. This bore is identified by reference numeral 38.

In FIG. 6, a brake shoe holder 5 of the invention is shown isometrically. The brake shoe holder 5, on the rear end in FIG. 6, has the aforementioned cylindrical bearing face 28, which serves to support the drive element 7. On the side of the brake shoe holder 5 oriented toward the observer, a receptacle 40 for a compression spring is embodied.

In the center of the brake shoe holder 5, there is a through bore 42, with which the brake shoe holder 5 is slipped onto the shaft 20. In the axial direction between the receptacle 40 and the bearing face 28, a stop 10 and a bearing bore 44 are embodied on the brake shoe holder 5.

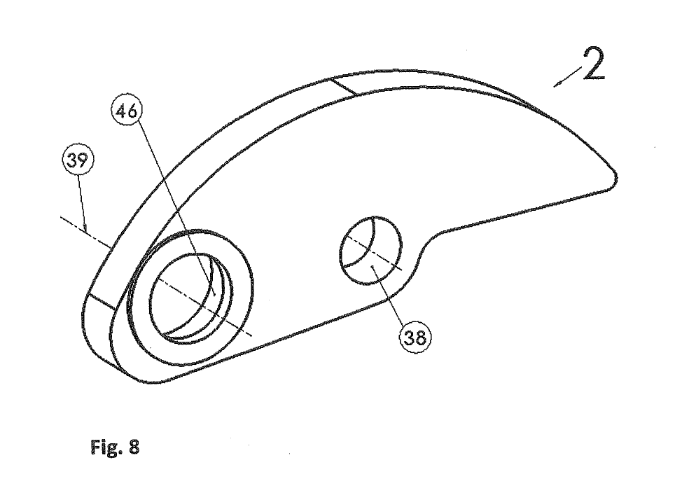

In FIG. 8, a brake shoe 2 of the invention is shown. The brake shoe 2 of the invention has a bore 38, which serves to receive the peg 8 on the radially inner end of the toggle lever 3. This bore 38 is located approximately in the middle of the brake shoe 2. A bearing bore 46 is embodied on the left end of the brake shoe 2 in FIG. 8. With the aid of a peg, not shown, the brake shoe 2 is supported rotatably on the brake shoe holder 5 in the vicinity of the bore 44.

Since the rotary motion of the brake shoe 2 relative to the brake shoe holder 5 encompasses only a small angular range, it is also called a pivoting motion. In other words, the brake shoe 2 is secured pivotably to the brake shoe holder 5. The pivot point of this pivoting motion is the center axis of the bore 44 and/or 46.

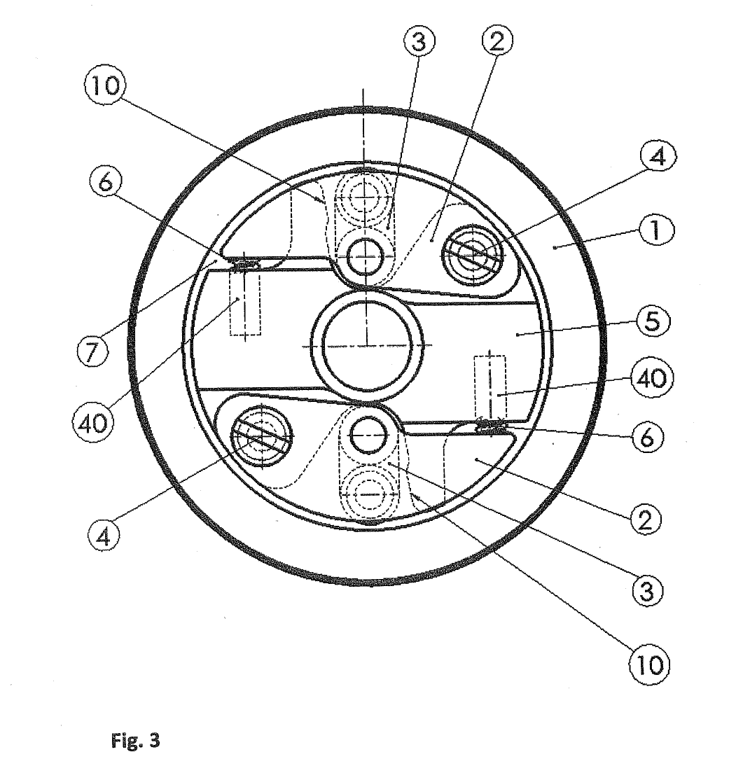

In FIG. 3, a section through the braking device of the invention along the line B-B in FIG. 2 is shown, in order to show clearly how the brake shoes 2 are borne on the brake shoe holder 5.

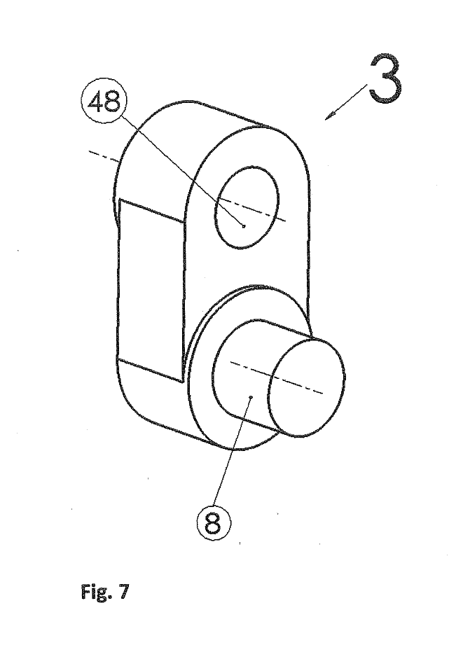

In FIG. 7, a toggle lever of the invention is shown. On one end, it has the peg 8 already mentioned several times, which is introduced into the bore 38 of the brake shoe. On the upper end in terms of FIG. 7, there is a female thread 48, into which the bearing bolt 9 (see FIG. 2 and FIG. 1) is screwed.

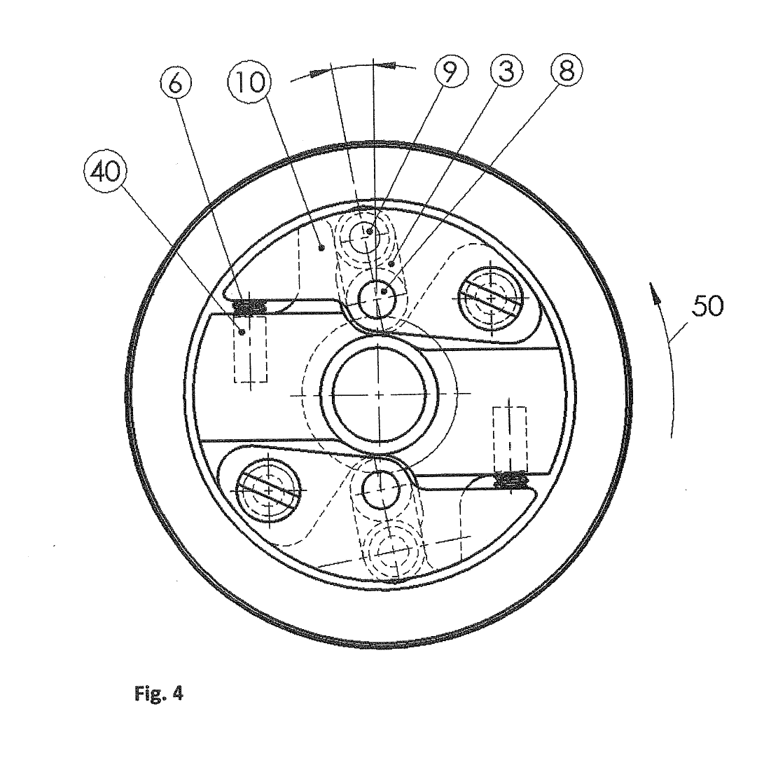

The stop 10 of the brake shoe holder 5 (see FIG. 6) serves to limit the travel of the toggle lever 3 in the drive direction. The term “drive direction” means that the drive element 7 transmits power to the tool 13 in the intended rotary direction (see the arrow 50 in FIG. 4).

In FIGS. 3, 4 and 5, sections along the line B-B in FIG. 2 are shown in various switching positions of the brake.

From these views, it becomes clear how the brake shoes 2 are pivotably secured to the brake shoe holder 5 with the aid of bearing bolts 4.

It can furthermore readily be seen that in each of the receptacles 40 of the brake shoe holder 5, there is one compression spring 6, which seeks to press the brake shoe 2 radially outward against the brake drum 1. Instead of a compression spring 6 wound as a spiral spring, other types of springs may also be used, whether tension springs with a corresponding deflection, or leaf springs, disk springs and others. It also suffices to use only a single spring.

The springs 6 effect an rpm-dependent (contact pressure) force with which the brake shoes 2 are pressed against the brake drum 1. It is understood that centrifugal forces may also become operative in a supporting and rpm-dependent fashion.

In FIG. 3, the toggle lever 3 is shown in a position in which the center points of the bearing bolt 9 and of the peg 8 are radially oriented, so that the toggle lever 3 is at dead center.

The toggle lever 3, as already mentioned, is secured by the bearing bolt 9 on the drive element 7 and is thus fixed in its radial orientation at this point. On the radially inner end of the toggle lever 3, the toggle lever, with its peg 8, engages the bore 38 of the brake shoe 2 and absorbs the force exerted radially outward by the spring 6. As a consequence, in the position shown of the toggle lever 3, the brake shoe 2 does not touch the brake drum 1; the braking device is deactivated.

In FIG. 4, the status of the braking device of the invention is now shown in which power is transmitted by the drive element 7 to the tool 13. The rotary direction is indicated in FIG. 4 by a curved arrow 50. In this case, the drive element 7 rotates the bearing bolt 9 and with it the toggle lever 3 counterclockwise, as indicated by the curved arrow 50. As a consequence, the toggle lever 3 comes into contact with the stop 10 of the brake shoe holder 5, and because of the resultant positive engagement between the toggle lever 3 and the brake shoe holder 5, the brake shoe holder 5 is set into rotation, likewise counterclockwise. Because the brake shoe holder 5 is connected to the shaft 20 in a manner fixed against relative rotation, the tool 13 is thus also driven.

In this position, the toggle lever 3 prevents the brake shoes 2 from coming into contact with the brake drum 1.

If the motor, which drives the drive element 7, is now switched off or shifted to idling, then the drive element 7 is braked by the motor, and because of the inertia of the tool 13, the clamping flanges 32, the shaft 20 and the brake shoe holder 5, the shaft 20 and with it the brake shoe holder 5 rotate faster than the drive element.

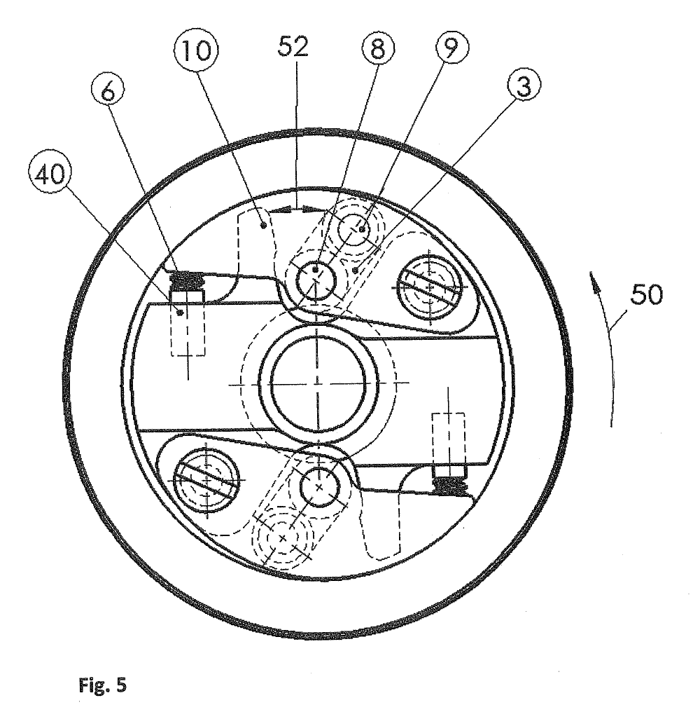

As a consequence, the toggle lever 3 no longer rests on the stop 10 but instead moves away from the stop 10 clockwise relative to it. This situation is shown in FIG. 5. The distance between the stop 10 and the toggle lever is represented by a double arrow 52.

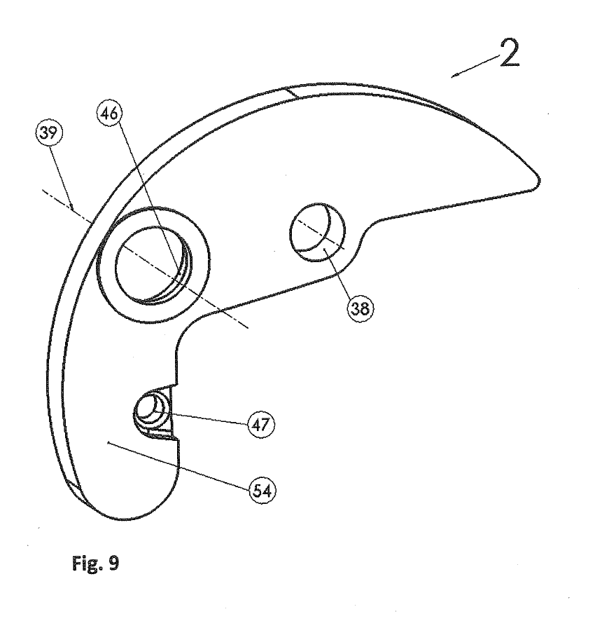

The distance comes about, as already mentioned, because the brake shoe holder 5 and with the tool 3 has rotated faster than the drive element has rotated faster than the drive element and the toggle lever 3 secured to the drive element. As soon as the toggle lever 3 has moved past dead center (see FIG. 4), the spring can press the brake shoe 2 against the brake drum 1; the braking device is activated. The contact pressure can be effected in part or entirely with the aid of one or more springs 6. In the example described, the springs 6 are embodied as compression springs. Another possibility would be to lengthen the brake shoes 2 on the other side of the rotary axis 4 (see FIG. 9), in order to generate the contact pressure by means of tension springs. It is also conceivable to press the brake shoes 2 outward or inward by means of leaf springs. The type of spring will be selected in accordance with the location of the attachment and/or in accordance with the brake drum with an inner or outer braking surface.

As a result of the centrifugal forces acting the brake shoe 2, the braking force exerted by the spring 6, above all at high rpm, is still further reinforced. This rpm-dependent self-reinforcement effect can be structurally defined by means of a suitable distribution of the mass of the brake shoe and the intrinsic weight of the brake shoe and adapted to the particular usage.

However, it is also possible to embody the brake shoe in a certain sense as a bell crank, as is indicated in FIG. 9. As a result, it is possible for the centrifugal forces acting on the brake shoe 2 to be compensated for entirely or partially relative to the pivot point in the vicinity of the bore 46, so that the braking force or contact pressure force with which the brake shoe 2 is pressed against the brake drum 1 is more or less rpm-dependent.

It is also expedient to position the pivot point (4) of the brake shoes such that self-reinforcement of the contact pressure force can be exploited. This is expedient if the working tool is operated in only one rotational direction.

To further increase the braking torque the brake shoes 2 can be designed such that they act like flyweights and thus increase the contact pressure force, particularly at high rpm. The rpm-dependent braking torque thus achieved can be structurally limited via counterpart flyweights on the other side of the pivot point 4 of the brake shoes 2 (see FIG. 9). The braking torque generated by centrifugal force can thus be designed according to the invention as arbitrarily positive, neutral, or negative.

It is also possible to suspend a spring in the bore 47, in order to increase the contact pressure force of the brake shoes 2.

1. A braking device for a driven tool, including a shaft, a fixed brake drum, a drive element, a brake shoe holder joined in a manner fixed against relative rotation to the shaft, wherein at least one brake shoe is pivotably located on the brake shoe holder, and wherein the brake shoe is activated when power or torque is transmitted from the shaft to the drive element.

2. The braking device of claim 1, wherein at least one brake shoe is located pivotably on the brake shoe holder and a toggle lever, a cam drive, in particular a sliding block guide or a ramp, is located between the drive element and at least one brake shoe.

3. The braking device of claim 2, wherein a stop is embodied on the brake shoe holder, which stop limits the travel of the toggle lever, the cam drive, the sliding block guide or the ramp and serves to transmit torque positively from the drive element to the shaft.

4. The braking device of claim 2 wherein the drive element is supported rotatably on a bearing face of the brake shoe holder.

5. The braking device of claim 1, wherein a spring is located between the brake shoe holder and the at least one brake shoe, and that the spring presses at least one brake shoe in the direction of the brake drum.

6. The braking device of claim 1, wherein the spring is embodied as a compression spring, tension spring, leg spring, spiral spring, leaf spring, or disk spring.

7. The braking device of claim 1, wherein the pivot points of the brake shoes are positioned such that the brake shoes are self-reinforcing.

8. The braking device of claim 1, wherein the brake shoes have flyweights.
